(19) United States
(12) Patent Application Publication
(10) Pub. No.: US 2007/0285368 A1
(43) Pub. Date: Dec. 13, 2007

(54) Driving circuit with mode switch circuit, liquid crystal display with same, and driving method for same

(75) Inventor: Tsung-Ping Liao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/811,525

(22) Filed: Jun. 11, 2007

(30) Foreign Application Priority Data
Jun. 9, 2006 (TW) 95120552

(51) Int. Cl. G09G 3/36

(52) U.S. Cl. 345/88

(57) ABSTRACT

An exemplary driving circuit (3) for a liquid crystal display (LCD) includes: an RGB (red green blue) signal interface (371) for receiving a plurality of RGB signals, a serial interface (372) for receiving a mode signal, a light emitting diode (LED) driving circuit (377), an LCD panel driver (376), a mode switch circuit (373) configured for receiving the RGB signals from the RGB signal interface, and a data transforming circuit (375). The mode switch circuit directly provides the received RGB signals to the LED driving circuit and the LCD panel driver when the LCD operates in a normal work mode. The data transforming circuit receives the RGB signals from the mode switch circuit, transforms the RGB signals to field sequential RGB signals, and provides the field sequential RGB signals to the LED driving circuit and the LCD panel driver when the LCD operates in a sequential work mode.

### FIELD OF THE INVENTION

The present invention relates to liquid crystal displays (LCDs) and, particularly, to an LCD which can be selected to operate in a normal work mode or a sequential work mode.

### GENERAL BACKGROUND

An LCD has the advantages of portability, low power consumption, and low radiation. LCDs have been widely used in various portable information products, such as: notebooks, personal digital assistants (PDAs), video cameras and the like. Furthermore, the LCD is considered by many to have the potential to completely replace CRT (cathode ray tube) monitors and televisions.

A typical LCD includes an LCD panel, a backlight for illuminating the LCD panel, and a driving circuit for driving the backlight and the LCD panel. The backlight can include one or more light emitting diodes (LEDs).

FIG. 3 is a block diagram including circuitry of a typical LCD 1. The LCD 1 includes an LCD panel 13, a plurality of light emitting diodes (LEDs) 15 for illuminating the LCD panel 13, and a driving circuit 17 for driving the LCD panel 13 and the LEDs 15. The LEDs 15 include a plurality of red LEDs (not shown), a plurality of green LEDs (not shown), and a plurality of blue LEDs (not shown).

The driving circuit 17 includes a red-green-blue (RGB) signal interface 171, a serial interface 172, an LED driving circuit 177, and an LCD panel driver 176.

An external circuit (not shown) such as a personal computer (PC) provides a plurality of RGB signals and a plurality of controlling signals to the LCD panel driver 176 via the RGB signal interface 171 and the serial interface 17, respectively. The LCD panel driver 176 drives the LCD panel 13 according to the received RGB signals and controlling signals in order to display images on the LCD panel 13. The external circuit also provides backlight driving signals to the LED driving circuit 177. The LED driving circuit 177 drives the LEDs 15 according to the received backlight driving signals in order to light the red LEDs, the green LEDs and the blue LEDs. Thus, the red LEDs, the green LEDs and the blue LEDs respectively emit red light, green light and blue light. The red light emitted from the red LEDs, the green light emitted from the green LEDs and the blue light emitted from the blue LEDs mix to form white light for illuminating the LCD panel 13. Operation of the LCD 1 as described above is defined as a normal work mode. When the LCD 1 operates in the normal work mode, the red LEDs, the green LEDs and the blue LEDs illuminate the LCD panel 13 with a maximal brightness at the same time.

FIG. 4 is a block diagram including circuitry of another typical LCD 2. The LCD 2 includes an LCD panel 23, a plurality of light emitting diodes (LEDs) 25 for illuminating the LCD panel 23, and a driving circuit 27 for driving the LCD panel 23 and the LEDs 25. The LEDs 25 include a plurality of red LEDs (not shown), a plurality of green LEDs (not shown), and a plurality of blue LEDs (not shown).

The driving circuit 27 includes an RGB signal interface 271, a serial interface 272, a data transforming circuit 275, an LED driving circuit 277, and an LCD panel driver 276.

An external circuit (not shown) such as a PC provides a plurality of RGB signals and a plurality of controlling signals to the data transforming circuit 275 via the RGB signal interface 271 and the serial interface 272, respectively. The data transforming circuit 275 transforms the RGB signals to field sequential RGB signals such that a red signal, a green signal and a blue signal are provided in that sequence and only one of the red signal, the green signal and the blue signal, is provided at any given time. Then the data transforming circuit 275 provides the field sequential RGB signals and the controlling signals to the LCD panel driver 276 and the LED driving circuit 277.

The LCD panel driver 276 drives the LCD panel 23 according to the received field sequential RGB signals and controlling signals in order to display an image on the LCD panel 23 such that a red image, a green image, and a blue image are sequentially displayed on the LCD panel 23.

The LED driving circuit 277 drives the LEDs 25 according to the received field sequential RGB signals and controlling signals in order to, sequentially, light the red LEDs, the green LEDs and the blue LEDs. Thus, the red LEDs, the green LEDs and the blue LEDs sequentially emit red light, green light and blue light to illuminate the LCD panel 23. A light-emitting sequence of the red light, the green light and the blue light corresponds to a display sequence of the red image, the green image, and the blue image on the LCD panel 23. Operation of the LCD 2 as described above is defined as a sequential work mode. When the LCD 2 operates in the sequential work mode, the LCD panel 23 sequentially displays the red image, the green image, and the blue image. At the same time, the red LEDs, the green LEDs and the blue LEDs sequentially illuminate the LCD panel 23 according to the required color of the images displayed on the LCD panel 23. Thus, when the LCD 2 operates in the sequential work mode, colors of the images displayed on the LCD 2 are rich and vibrant.

The LCD 1 only operates in the normal work mode. When the LCD 1 operates in the normal work mode and the environment is dim or dark, the red LEDs, the green LEDs and the blue LEDs illuminate the LCD panel 13 with a maximal brightness, and thus the power consumption of the LCD 1 is large. The LCD 2 only operates in the sequential work mode. When the LCD 2 operates in the sequential work mode and the environment is bright, the images displayed on the LCD panel 23 may be barely visible because of much ambient light being reflected from the LCD panel 23.

It is desired to provide an LCD which can overcome the above-described deficiencies.

### SUMMARY

In one preferred embodiment, a driving circuit for an LCD includes: an RGB signal interface configured for receiving a plurality of RGB signals from an external circuit, a serial interface configured for receiving a mode signal from the external circuit, an LED driving circuit configured for driving a plurality of LEDs of the LCD, an LCD panel driver configured for driving an LCD panel of the LCD, a mode switch circuit configured for receiving the RGB signals from the RGB signal interface, and a data transforming circuit. The mode signal includes a signal selected from the group consisting of a signal representing a normal work mode and a signal representing a sequential work mode. The mode switch circuit is configured for directly providing the received RGB signals to the LED driving circuit and the LCD panel driver, when the LCD operates in a normal work mode. The data transforming circuit is configured for receiving the RGB signals from the mode switch circuit, transforming the RGB signals to field sequential RGB signals, and providing the field sequential RGB signals to the LED driving circuit and the LCD panel driver when the LCD operates in a sequential work mode.

Other novel features and advantages will become more apparent from the following detailed description when taken in conjunction with the accompanying drawings.

### BRIEF DESCRIPTION OF THE DRAWINGS

FIG. 1 is a block diagram including circuitry of an LCD according to a first embodiment of the present invention.

FIG. 2 is a block diagram including circuitry of an LCD according to a second embodiment of the present invention.

FIG. 3 is a block diagram including circuitry of a conventional LCD.

FIG. 4 is a block diagram including circuitry of another conventional LCD.

### DETAILED DESCRIPTION OF PREFERRED EMBODIMENTS

Reference will now be made to the drawings to describe various embodiments of the present invention in detail.

FIG. 1 is a block diagram including circuitry of an LCD 3 according to a first embodiment of the present invention. The LCD 3 includes an LCD panel 33, a plurality of light emitting diodes (LEDs) 35 for illuminating the LCD panel 33, and a driving circuit 37 for driving the LCD panel 33 and the LEDs 35. The LEDs 35 include a plurality of red LEDs (not shown), a plurality of green LEDs (not shown), and a plurality of blue LEDs (not shown).

The driving circuit 37 includes an RGB signal interface 371, a serial interface 372, a mode switch circuit 373, a data transforming circuit 375, an LED driving circuit 377, and an LCD panel driver 376.

An external circuit (not shown) such as a PC provides a plurality of RGB signals to the mode switch circuit 373 via the RGB signal interface 371. The external circuit also provides a plurality of controlling signals respectively to the mode switch circuit 373, the data transforming circuit 375, and the LCD panel driver 376 via the serial interface 372. The controlling signals provided to the mode switch circuit 373 include a mode signal, which represents either a normal work mode or a sequential work mode.

When the mode switch circuit 373 receives a mode signal representing a normal work mode, the mode switch circuit 373 directly provides the received RGB signals to the LCD panel driver 376 and the LED driving circuit 377. Thus, the LCD 3 operates in a normal work mode.

The LCD panel driver 376 drives the LCD panel 33 according to the received RGB signals and the controlling signals in order to display color images on the LCD panel 33. The LED driving circuit 377 drives the LEDs 35 for lighting the red LEDs, the green LEDs and the blue LEDs with a maximal brightness at the same time. The red light emitted from the red LEDs, the green light emitted from the green LEDs and the blue light emitted from the blue LEDs mix to form white light for illuminating the LCD panel 33.

When the mode switch circuit 373 receives a mode signal representing a sequential work mode, the mode switch circuit 373 provides the received RGB signals to the data transforming circuit 375. Thus, the LCD 3 operates in a sequential work mode.

The data transforming circuit 375 transforms the RGB signals to field sequential RGB signals such that a red signal, a green signal and a blue signal are provided in that sequence and only one of the red signal, the green signal and the blue signal is provided at any one time. Then the data transforming circuit 375 provides the field sequential RGB signals to the LCD panel driver 376 and the LED driving circuit 377.

The LCD panel driver 376 drives the LCD panel 33 according to the received field sequential RGB signals and controlling signals, in order to display images on the LCD panel 33, such that a red image, a green image, and a blue image are sequentially displayed on the LCD panel 33.

The LED driving circuit 377 drives the LEDs 35 according to the received field sequential RGB signals, in order to sequentially light the red LEDs, the green LEDs and the blue LEDs. Thus, the red LEDs, the green LEDs and the blue LEDs sequentially emit red light, green light and blue light to illuminate the LCD panel 33. A light-emitting sequence of the red light, the green light and the blue light corresponds to a display sequence of the red image, the green image, and the blue image on the LCD panel 3. When the LCD 3 operates in the sequential work mode, the LCD panel 33 sequentially displays the red image, the green image, and the blue image. The red LEDs, the green LEDs and the blue LEDs of the LEDs 35 sequentially illuminate the LCD panel 33 according to the required color of the images displayed on the LCD panel 33. Thus, colors of the images displayed on the LCD 3 are very rich.

Because the LCD 3 includes the mode switch circuit 373, the LCD 3 may be selected to operate in the normal work mode or in the sequential work mode according to user demand. When the environment is bright, a user may select that the LCD 3 operates in the normal work mode to depress the effect of reflected light. When the environment is dim or dark, the user may select that the LCD 3 operates in the sequential work mode to display rich, vibrant color pictures on the LCD panel 33.

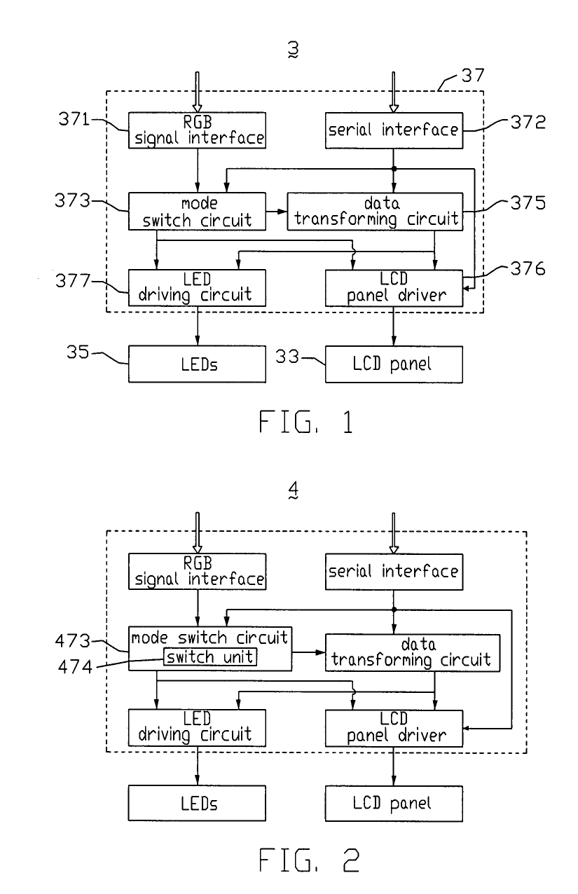

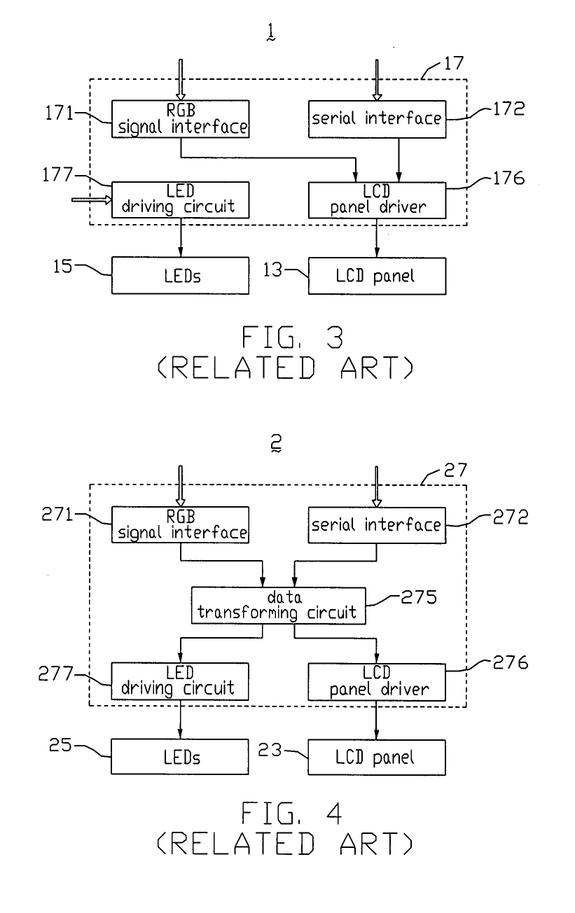

FIG. 2 is a block diagram including circuitry of an LCD according to a second embodiment of the present invention. The LCD 4 is similar to the LCD 3 of the first embodiment. However, a mode switch circuit 473 of the LCD 4 includes a switch unit 474. The switch unit 474 is integrally formed in the mode switch circuit 473, and is configured for controlling operation of the mode switch circuit 473. Thus the LCD 4 may be selected to operate in a normal work mode or a sequential work mode.

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of arrangement of parts within the principles of present invention to the full extent indicated by the broad general meaning of the terms in which the appended claims are expressed.

What is claimed is:

1. A driving circuit for a liquid crystal display (LCD), the driving circuit comprising:
an RGB (red green blue) signal interface configured for receiving a plurality of RGB signals from an external circuit;
a serial interface configured for receiving a mode signal from the external circuit, the mode signal comprising a signal selected from the group consisting of a signal representing a normal work mode and a signal representing a sequential work mode;
a light emitting diode (LED) driving circuit configured for driving a plurality of light emitting diodes (LEDs) of the LCD;
an LCD panel driver configured for driving an LCD panel of the LCD;
a mode switch circuit configured for receiving the RGB signals from the RGB signal interface; and
a data transforming circuit;
wherein the mode switch circuit directly provides the received RGB signals to the LED driving circuit and the LCD panel driver when the LCD operates in the normal work mode; and
the data transforming circuit receives the RGB signals from the mode switch circuit, transforms the RGB signals to field sequential RGB signals, and provides the field sequential RGB signals to the LED driving circuit and the LCD panel driver when the LCD operates in the sequential work mode.

2. The driving circuit as claimed in claim 1, wherein the mode switch circuit is configured for selecting the normal work mode or the sequential work mode of the LCD according to the mode signal.

3. The driving circuit as claimed in claim 3, wherein the mode switch circuit comprises a switch unit, and the switch unit is configured for controlling operation of the mode switch circuit.

4. The driving circuit as claimed in claim 1, wherein when the LCD operates in the normal work mode, the LED driving circuit drives the LEDs according to the RGB signals such that a plurality of red LEDs, a plurality of green LEDs and a plurality of blue LEDs of the LEDs are lit with a maximal brightness at the same time.

5. The driving circuit as claimed in claim 1, wherein when the LCD operates in the normal work mode, the LCD panel driver drives the LCD panel to display color images according to the RGB signals.

6. The driving circuit as claimed in claim 1, wherein when the LCD operates in the sequential work mode, the LCD panel driver drives the LCD panel to display images such that a red image, a green image, and a blue image are sequentially displayed.

7. The driving circuit as claimed in claim 1, wherein when the LCD operates in the sequential work mode, the LED driving circuit drives the LEDs according to the field sequential RGB signals such that a plurality of red LEDs, a plurality of green LEDs and a plurality of blue LEDs of the LEDs are lit sequentially one plurality after another.

8. A driving method for a liquid crystal display (LCD), the method comprising:
receiving a plurality of RGB (red green blue) signals and a mode signal, the mode signal comprising a signal selected from the group consisting of a signal representing a normal work mode and a signal representing a sequential work mode;
providing the received RGB signals to a light emitting diode (LED) driving circuit and an LCD panel driver when the LCD operates in the normal work mode; and
transforming the RGB signals to field sequential RGB signals, and providing the field sequential RGB signals to the LED driving circuit and the LCD panel driver when the LCD operates in the sequential work mode.

9. The driving method as claimed in claim 8, further comprising selecting the LCD to operate in the normal work mode or the sequential work mode according to the mode signal.

10. The driving method as claimed in claim 8, wherein when the LCD operates in the normal work mode, the LED driving circuit drives a plurality of red LEDs, a plurality of green LEDs and a plurality of blue LEDs to be lit with a maximal brightness at the same time according to the RGB signals.

11. The driving method as claimed in claim 8, wherein when the LCD operates in the normal work mode, the LCD panel driver drives an LCD panel to display color images according to the RGB signals.

12. The driving method as claimed in claim 8, wherein when the LCD operates in the sequential work mode, the LCD panel driver drives an LCD panel to display images such that a red image, a green image, and a blue image are sequentially displayed.

13. The driving method as claimed in claim 8, wherein when the LCD operates in the sequential work mode, the LED driving circuit drives a plurality of red LEDs, a plurality of green LEDs and a plurality of blue LEDs to be lit sequentially one plurality after another.

14. A liquid crystal display (LCD) comprising:
an LCD panel;
an LCD panel driver configured for driving the LCD panel;
a plurality of light emitting diodes (LEDs) arranged for illuminating the LCD panel;
a light emitting diode (LED) driving circuit configured for driving the LEDs;
an RGB (red green blue) signal interface configured for receiving a plurality of RGB signals from an external circuit;
a serial interface configured for receiving a mode signal from the external circuit, the mode signal comprising a signal selected from the group consisting of a signal representing a normal work mode and a signal representing a sequential work mode;
a mode switch circuit configured for receiving the RGB signals from the RGB signal interface; and
a data transforming circuit;
wherein the mode switch circuit directly provides the received RGB signals to the LED driving circuit and the LCD panel driver when the LCD operates in the normal work mode; and
the data transforming circuit receives the RGB signals from the mode switch circuit, transforms the RGB signals to field sequential RGB signals, and provides the field sequential RGB signals to the LED driving circuit and the LCD panel driver when the LCD operates in the sequential work mode.

15. The LCD as claimed in claim 14, wherein the mode switch circuit is configured for selecting the normal work mode or the sequential work mode of the LCD according to the mode signal.

16. The LCD as claimed in claim 15, wherein the mode switch circuit comprises a switch unit, and the switch unit is configured for controlling operation of the mode switch circuit.

17. The LCD as claimed in claim 14, wherein when the LCD operates in the normal work mode, the LED driving circuit drives the LEDs according to the RGB signals such that a plurality of red LEDs, a plurality of green LEDs and a plurality of blue LEDs of the LEDs are lit with a maximal brightness at the same time.

18. The LCD as claimed in claim 14, wherein when the LCD operates in the normal work mode, the LCD panel driver drives the LCD panel to display color images according to the RGB signals.

19. The LCD as claimed in claim 14, wherein when the LCD operates in the sequential work mode, the LCD panel driver drives the LCD panel to display images such that a red image, a green image, and a blue image are sequentially displayed.

20. The LCD as claimed in claim 14, wherein when the LCD operates in the sequential work mode, the LED driving circuit drives the LEDs according to the field sequential RGB signals such that a plurality of red LEDs, a plurality of green LEDs and a plurality of blue LEDs of the LEDs are lit sequentially one plurality after another
